(19) United States
(12) Patent Application Publication
(10) Pub. No.: US 2016/0047029 A1
(43) Pub. Date: Feb. 18, 2016

(54) Method and Apparatus for Depositing Protective Coatings and Components Coated Thereby

(71) Applicant: AEROMET TECHNOLOGIES, INC., Sandy, UT (US)

(72) Inventor: David C. Fairbourn, Sandy, UT (US)

(73) Assignee: AEROMET TECHNOLOGIES, INC., Sandy, UT (US)

(21) Appl. No.: 14/777,517

(22) PCT Filed: Mar. 18, 2014
(86) PCT No.: PCT/US14/00063

§ 371 Date: Sep. 16, 2015

Related U.S. Application Data
(60) Provisional application No. 61/801,990, filed on Mar. 15, 2013.
(60) Provisional application No. 61/802,290, filed on Mar. 15, 2013.

(51) Int. Cl. C23C 10/26; F01D 5/28; B32B 15/01; C23C 28/02; B05C 13/02

(52) U.S. Cl. CPC C23C 10/26; C23C 28/021; B05C 13/02; B32B 15/01; B32B 15/017; F01D 5/288

(57) ABSTRACT

A method and apparatus for forming a coating on a surface of a superalloy substrate area of a gas turbine engine component, and the component produced by the method, includes providing a slurry with selected metal powders suspended in a silane containing solution, applying the slurry by brushing, spraying or 3D printing using a piezoelectric dot matrix printhead to the superalloy substrate, drying the applied slurry, and depending on the aluminum content desired in the coating, including a sufficient amount of aluminum in the slurry or aluminiding the coated component. The method and apparatus can be used to obtain components having different superalloy coating thicknesses or compositions in different areas of the component based on the particular operating environment for each area with a single heat treatment and/or aluminiding cycle for obtaining the different coatings.

### CROSS REFERENCE TO RELATED APPLICATIONS

U.S. Provisional Patent Application Ser. No. 61/801,990, filed Mar. 15, 2013, teaches Advanced Methods of Depositing Protective Coatings and Coated Components; and U.S. Provisional Patent Application Ser. No. 61/802,290, filed Mar. 15, 2013, teaches New Technology Inkjet Spraying of Jet Engine Turbine Components. The present application incorporates U.S. Ser. Nos. 61/801,990 and 61/802,290 herein by reference.

### TECHNICAL FIELD

The present invention is directed to apparatus and process for providing a protective coating to a gas turbine engine component and the components formed thereby.

### BACKGROUND

A typical gas turbine engine includes a compressor section with shaft mounted blades for compressing air that is then directed into a combustor where fuel is mixed with the air and ignited, the heated gases then expanding through a high-pressure turbine (HPT) which includes stationary vanes and rotating turbine blades mounted on the same shaft driving the compressor, and then through a low pressure turbine (LPT) with blades mounted on a second shaft which drives a fan to provide thrust in the case of an aircraft jet engine, or drives an electrical generator in the case of a power generating gas turbine engine. The efficiency of any gas turbine engine is enhanced by reaching higher temperatures. Components of gas turbine engines are often manufactured from nickel-, cobalt-, or iron-based superalloy materials. Although superalloy materials exhibit improved mechanical properties at high operating temperatures, they are nonetheless susceptible to three types of degradation limiting the component's useful life; hot corrosion, stress corrosion cracking (also generally referred to as Type I and Type II corrosion, respectively, and as sulfidation), and high temperature oxidation. The temperature ranges at which Type I and Type II corrosion, and High Temperature Oxidation, degrade the superalloy may depend on the superalloy composition.

The ability to achieve even higher engine operating temperatures has been enabled through the use of coatings on superalloy components. Coatings can be used either alone as an environmental coating (to protect the component, also referred to hereinafter as a part, directly from corrosion or oxidation) or as a bond coat for a subsequently applied thermal barrier coating (TBC), such as Yttria stabilized zirconia (YSZ) applied to surfaces exposed to hot gases, particularly flowpath surfaces. Exemplary superalloy coatings include MCrAIY (where M represent one or more of Fe, Co, and Ni), platinum aluminides, and nickel aluminides, each of which provide a source of aluminum to form and replenish a thermally grown oxide (TGO) layer of alumina (Al2O3) on their surface when exposed to oxygen at high temperatures, the alumina providing an effective protection against high temperature oxidation. Many variations of these base superalloy coating compositions have been made to include other beneficial elements.

Various methods have been developed for the application of superalloy coatings, including thermal spray processes such as plasma sprays (e.g., air plasma spray (APS), low pressure plasma spray (LPPS)) and high velocity oxy-fuel (HVOF), electroplating, and chemical vapor deposition (CVD) processes. Some of these processes have been used in combination to achieve the desired superalloy coating, such as the process described below for obtaining a platinum aluminide. Superalloy coatings are conventionally applied to be as uniform in thickness as possible across the component substrate surface.

Different portions of the same part can have different operating environments, and thus different coating needs. HPT and LPT blades and vanes can be considered as having a flowpath portion with surfaces exposed to the hot core airflow gases (such as above a blade platform) and a non-flowpath portion operating in a cooler environment (such as below the blade platform). The flowpath portion can be cooled by various mechanisms, including cooling air circulated internally and exhausted through cooling holes to the surface. For example, where the cooling air inlet is around 1100° F., a blade operating temperature can be somewhere between the 1100° inlet and a 1700° F. operating temperature, often in the 1300-1500° F. range. It is entirely possible and in fact does occur that all three degradation mechanisms are functioning on a blade, in different areas, at the same time. Thus different areas of the component may have different coatings applied, such as a platinum aluminide on a turbine blade airfoil subject to high temperature oxidation and an MCrAIY below the platform where chromium in the coating is especially beneficial in preventing sulfidation. Multiple coatings on a single part requires the part undergo multiple processes and heat cycles. Blade surfaces in contact with other surfaces, such as a blade dovetail “fir tree” are typically kept free of any alumina forming coating.

Superalloy coatings, while often intermetallics, may themselves be considered an alloy, and at least some coating processes have included an age heat treatment to diffuse the coating and substrate to reduce the brittleness of the coating if the coating has brittle characteristics.

As an example of one superalloy coating and method, platinum aluminides are conventionally formed by electroplating a very thin layer (e.g., nominally about 0.5 to 5 microns) of platinum on the engine component and subsequently providing an enriched source of aluminum, such as by CVD.

Platinum electroplating processes require an electroplating bath using an expensive platinum containing salt in solution. Typically the electroplating process itself can add 100% to the cost of the platinum. Electroplating processes use conductive electrolytes containing phosphates which result in at least trace amounts of phosphorus in the coating, and typically result in only 50-55% of the platinum from the electroplating solution actually plated on the part. Trace amounts of sulfur have also been found in plating baths and plated coatings. A primary goal of coating vendors is to apply the minimum platinum required in as uniform a layer as is possible at the lowest cost. Conventional platinum electroplating processes also result in excess deposits on any area where there is concentration of current density. Sharp corners and prominent edges and surfaces get extra while concave surfaces and inner filet radius get lesser amounts of platinum.

U.S. Pat. No. 5,492,726, to Rose, et.al., teaches that adding silicon to form a platinum silicon aluminide results in improved platinum performance. The patent only describes this application as a siliciding step. Other patents also describe the application of chromium, aluminide, and platinum coatings.

U.S. Pat. No. 7,229,701 to Madhava, et.al., discloses that a chromium platinum aluminide is a superior coating as well, but that the coating can only be made in an Electron Beam-Physical Vapor Deposition (EB-PVD) coating operation or using selected sequential diffusion processing steps, both very expensive processes.

U.S. Pat. No. 6,216,758 to Meelu et al. teaches aluminide-silicide coatings using a slurry process and includes a description of a commercially available process available under the trade name “Sermaloy J.” The disclosure of this patent is hereby incorporated by reference.

It is the desire of all operators to have gas turbine engine parts, including, blades, vanes or shrouds, or IGT Articles Buckets, nozzles and plates last as long as possible. It is common to replace the coatings to lengthen the life of the parts. When parts are returned for recoating they must be stripped first. During the stripping operation, pristine coating areas have been found while in other areas the coatings have been observed to be vacant or highly degraded.

U.S. Pat. No. 6,605,161 to Fairbourn teaches the use of silane as an inoculant. The patent describes applying a 5% or 10% mixture of a silane to enhance formation of an aluminide coating. Silane comes neat as an oil. It is diluted with methanol after hydrolyzing the silane with acetic acid and water. The silane is a combination of silicon, carbon, hydrogen and oxygen. When it breaks down due to heat, the silicon is protected so that it does not oxidize. Therefore it is in form that permits diffusion to occur. The silane is dried and then the part CVD aluminized to form a coating with enhanced deposition of aluminum where the inoculant was applied. It is understood that an inoculant is different than a conventional coating, it is a very small amount of material that enhances the rate of deposition and growth of the intermetallic layer. The silicon for the inoculant is only made available directly from the silane and is a relatively minor amount, less than 0.8% of the aluminide coating. The inoculant can also be a Lewis acid with a metal ion selected for its beneficial properties in a coating, and can be applied to specific areas to enable different thickness of the intermetallic layer formed during the CVD aluminization by enhancing the rate of deposition.

Based on the issues discussed above, there is a need for improving the process to economically apply coatings to superalloy components used in gas turbine engines, and a need for improved coatings.

### SUMMARY

A method for forming a coating on a superalloy part for a gas turbine engine is provided, including the steps of mixing a slurry using a silane as a binder with selected metal powder(s) to obtain a desired coating, including where desired use of aluminum containing powders and/or an aluminization step if needed. A slurry deposition rate can be varied to enable additional coating material in particular areas of the part, and/or different slurries can be used in different areas to obtain the desired coating composition or thickness most beneficial in each area. The slurry or slurries can be applied by various methods including brushing, spraying, or 3D printing, and use of multiple slurries can enable elimination of one or more process steps, such as heating cycles, that would conventionally be required to apply different coating compositions to different areas of the part. Preferably the silane is not hydrolyzed, which eliminates water from being introduced into equipment used in the coating process and the consequential deleterious effects. In order for the slurry to be sprayed or printed using a 3D print system, the viscosity is reduced using an alcohol to permit better flow.

Apparatus for use in performing the method are described, including an enclosure which resembles a stage to withdraw air over the part being coated with a slurry, exhausting fumes and recovering any overspray as the metal powders used can be quite valuable.

Other apparatus for coating a part in accordance with the method is described as having means for agitating the slurry to keep the powder suspended while applying by spraying or a 3D print system, such as one using a piezoelectric dot matrix printer. A 3D print system is described as a combination of a piezoelectric dot matrix printer for use in conjunction with a gantry system upon which the gas turbine engine part is mounted, thus allowing essentially five degrees of freedom of movement to enable complete access to “print” on all part areas. Multiple printheads can be used, each having an associated reservoir for holding a slurry. Products obtained by this process avoid the use of electroplating solutions that contain constituents deleterious to a coating, thus enabling a coating free of any such deleterious constituents.

### BRIEF DESCRIPTION OF THE DRAWINGS

The accompanying drawings, which are incorporated in and constitute a part of this specification, illustrate embodiments of the invention and together with the detailed description given below, serve to explain various aspects of the invention.

FIG. 1 is a block diagram of steps used in a method of coating gas turbine engine components.

FIG. 2 is an upper isometric view of a gas turbine blade showing the pressure side.

FIG. 2A is a partial, cross-sectional, schematic view of the blade showing an environmental coating on its surface.

FIG. 2B is a partial, cross-sectional, schematic view of the blade showing a TBC and bond coat on its surface.

FIG. 3 is a lower isometric view of a blade showing the pressure side.

FIG. 4 is a front elevational view of the coating booth of FIG. 7 showing an exemplary spray device coating a gas turbine engine component.

FIG. 5 is a table listing example gas turbine engine blade areas and an exemplary slurry composition for each area of a blade coated with a TBC.

FIG. 6 is a table listing example gas turbine engine blade areas and an exemplary slurry composition for each area for a blade without TBC.

FIG. 7 is a plan view of a coating booth with exhaust stack.

FIG. 8 is a front elevational view of the coating booth of FIG. 7, showing an exemplary 3-D print system including a gantry device, with a gas turbine engine component mounted therein being coated in accordance with principles of the present invention.

FIG. 9 is a section view of the coating booth of FIG. 7 taken along lines 8-8.

FIG. 10 is a rear elevational view of the coating booth with the exhaust stack shown in phantom.

FIG. 11 is a plan view of the coating mechanism of FIG. 7 with the center portion of the spray gantry broken and shown in phantom for clarity

FIG. 12 is a section view of the coating mechanism of FIG. 7 taken along line 12-12 of FIG. 11

FIG. 13 is a schematic view showing gas turbine engine components, such as that from FIG. 2, in a deposition environment of a simple CVD furnace for purposes of explaining the principles of the present invention.

### DETAILED DESCRIPTION

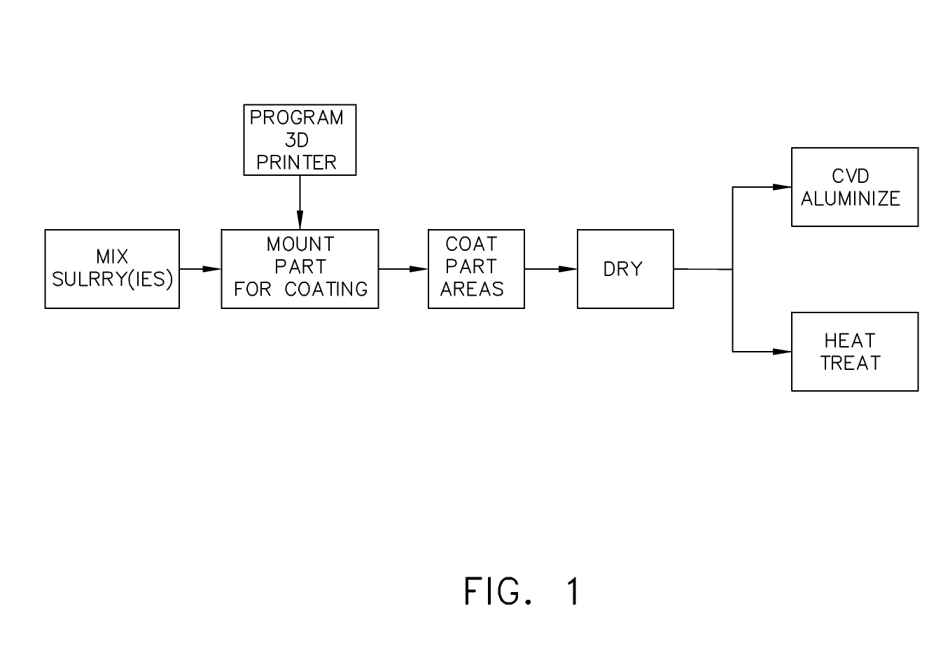

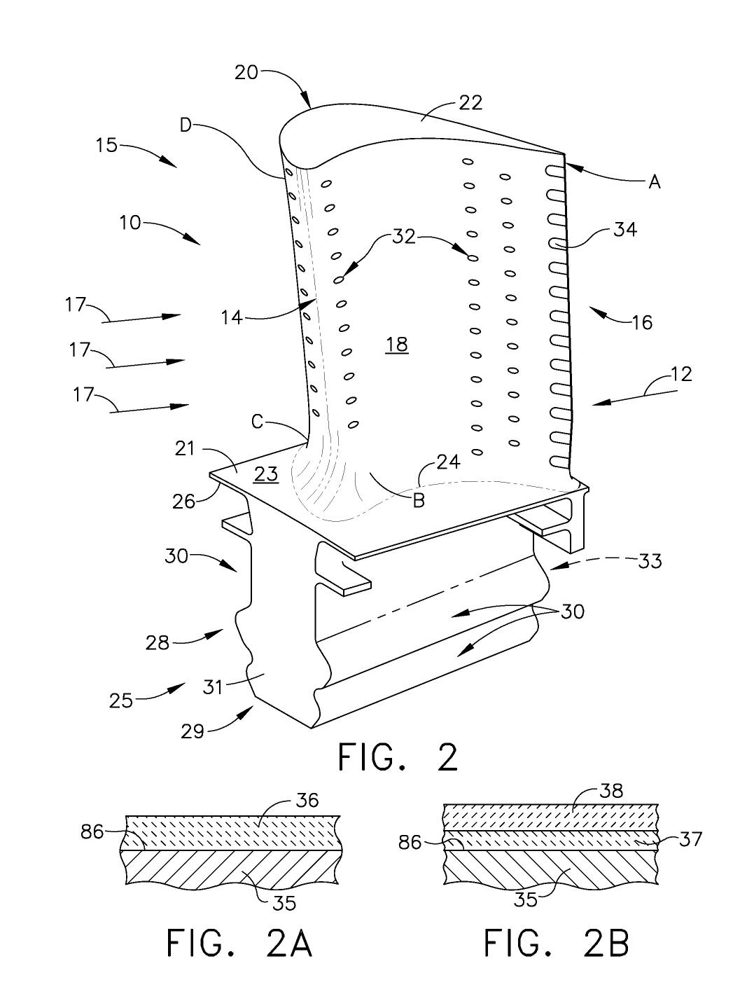

FIG. 1 shows the steps used in a method of coating gas turbine engine components (15) such as depicted in FIG. 2, and also referred to as a “part.” As will be further explained below with reference to particular examples, a nominal composition for a slurry is determined including a non-hydrolyzed silane and one or more metal powders that will result in a desired coating after an appropriate heat cycle. More than one slurry composition can be used in this process to enable different coatings on different areas. The part is mounted to enable application of the coating slurry, whether by a spray or brush process, or use of a 3-D printer which can be programmed for the particular part and coating desired, including differences in compositions and application rates on different areas. The appropriate areas of the part or coated and then the parts are dried in a manner that the silane acts as a binder to keep the metal powders in place during a subsequent heat treatment. Some coatings do not require aluminum and thus will only need a heating cycle for melting/diffusion of the slurry materials in forming the coating. An appropriate heating cycle, also referred to as a “heat treat” or “heat treatment” may obtain the final coating desired for use as an environmental coating or a bond coat (for further application of a thermal barrier coating) without the need for an aluminization cycle if sufficient aluminum powders are used for a coating that would conventionally require aluminizing. Alternatively, the slurry may be formulated to contain no or only a small amount of aluminum and after drying the part can be put through a conventional aluminizing cycle, such as a chemical vapor deposition aluminizing.

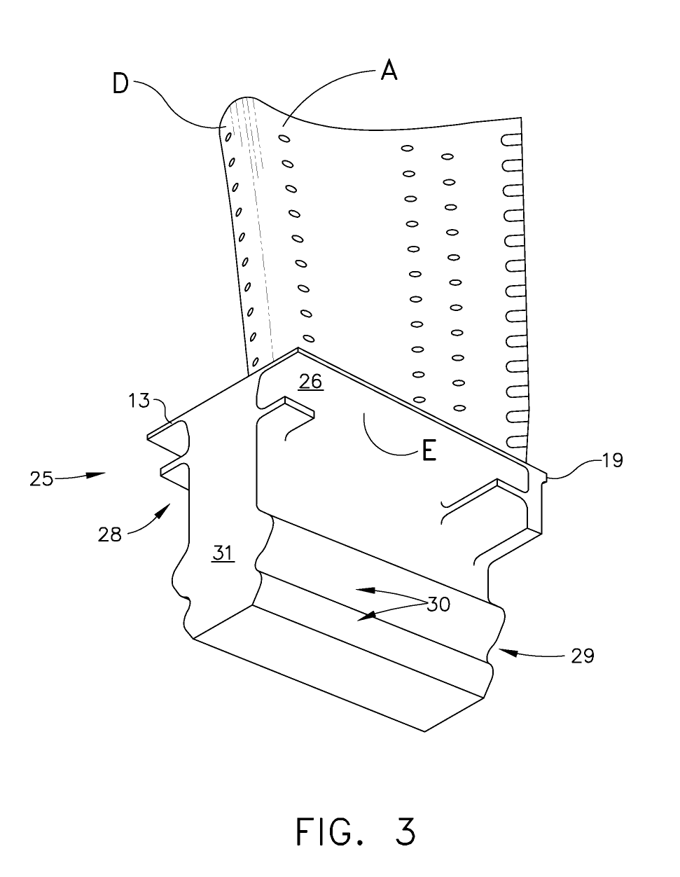

With reference to FIGS. 2 and 3, and exemplary gas turbine engine component 15 that can be coated by the process and using the apparatus described below is shown as a gas turbine engine blade 10. Turbine blade 10 is shown having a platform 21 with an upper surface 23 and a lower surface 26 extending from a forward end 13 to an aft end 19, with an airfoil 12 extending outward from the platform upper surface 23 at a fillet radius 24 to the blade tip 22, with a concave side 18, also referred to as the pressure side, and a convex side 20, also referred to as the suction side, extending from a leading edge 14 proximate the forward end 13 of the blade 10 to a trailing edge 16 proximate the aft end 19 of the blade 10. Flow lines 17 depict the direction of airflow during engine operation which flows past a flowpath portion 11 of the blade 10 defined by the platform upper surface 23 and surfaces of the airfoil 12. A blade root 28 extends inward from the platform lower surface 26 to a lower dovetail section 29 for attachment to the rotor (not shown) along pressure surfaces 30 extending from a forward face 31 to an aft face 33. Portions of the blade can be coated with an environmental coating 36 on the substrate material 35 as shown in FIG. 2A or with a bond coat 37 and TBC 38 as shown in FIG. 2B. Cooling holes 32 and trailing edge slots 34 exhaust cooling air from the internal circuits of the blade into the gas flow path during engine operation and work in combination with TBC 38 when applied to maintain the metal blade to its design operating temperature. As previously discussed, different areas of the blade operate at different temperatures, generally from cooler locations underneath the platform that may be coated with an environmental coating 36, to harsher environments above the platform that may be coated with only an environmental coating 36 or such coating acting as a bond coat 37 to a TBC 38 in one or more discreet areas up to and including the entire platform upper surface 23 and airfoil 12. It should also be noted that the lower dovetail section 29 has shapes that are very sensitive to very tight tolerances, and thus in most coating applications they must be masked.

Conventionally, a single composition coating will be applied to the entire flowpath portion 11 and a different composition coating will be applied to the platform lower surface, requiring multiple heat cycles. The methods and apparatus described below can enable different compositions and different concentrations or thicknesses to be applied in different areas based on their different operating conditions, such as the concave trailing edge A, concave leading-edge near the fillet radius B, convex leading-edge near the fillet radius C, the convex leading edge near the tip D, and under the platform E, as shown in FIGS. 2 and 3.

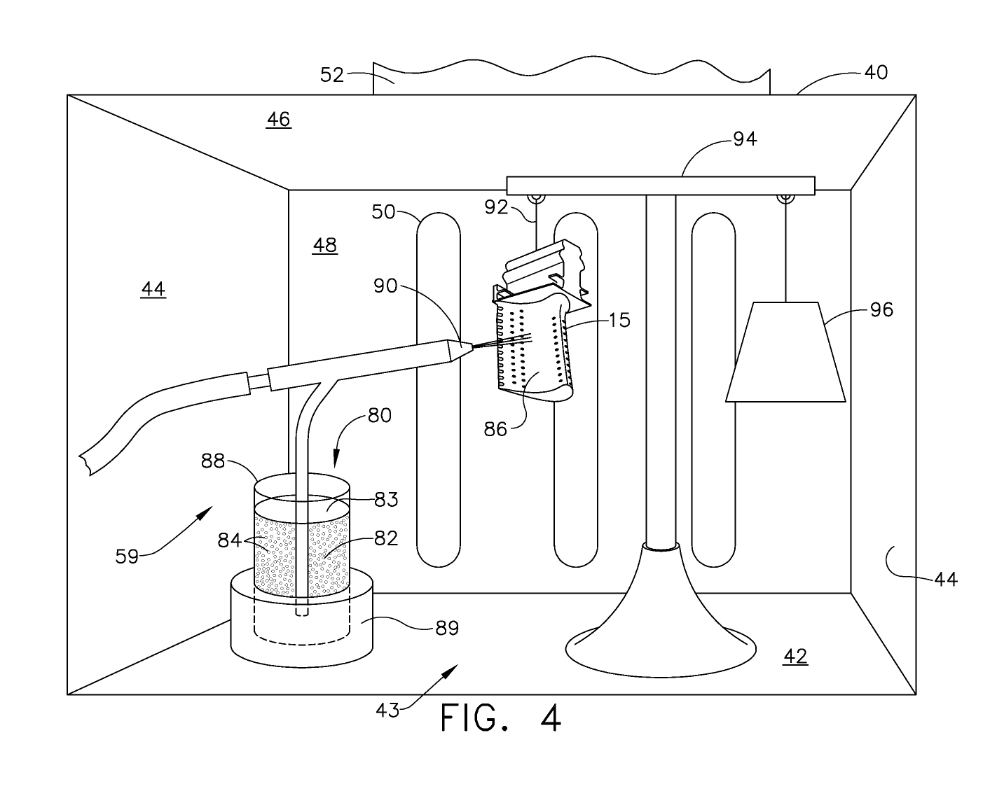

As depicted in FIG. 4, a slurry 80 made by mixing a metal powder 84 into a liquid 83 that can hold the metal powder particles in suspension, can be used to apply a desired nominal composition to a surface of a gas turbine engine component 15, the composition of the liquid 83 selected so that when dried it acts as a binder to hold the particles substantially in place on the surface in order to obtain a desired coating for use as an environmental coating 36 or a bond coat 37 as the binder and/or particles melt and/or diffuse during subsequent heating.

A preferred binder is a silane material, including mono, bis or tri functional trialkoxy silane. The silane may be a bifunctional trialkoxy silyl, preferably trimethoxy or triethoxy silyl groups. Also amino silanes may be used, although thio silanes may not be desired due to the sulfur content therein. Bisfunctional silane compounds are well known and two preferred for use in the present invention are bis(triethoxysilyl) ethane (BTSE) and bis(trimethoxysilyl) methane. In both of these compounds the bridging group between the two silane moieties is an alkyl group.

Additional commercially available silanes include:

1,2-Bis(tetramethyldisoloxanyl)

Ethane 1,9-Bis(triethoxysilyl) Nonane

Bis(triethoxysilyl) Octane,

Bis(trimethoxysilyl) Ethane

1,3-Bis(trimethylsiloxy)-1,3-Dimethyl Disiloxane

Bis(trimethylsiloxy) Ethylsilane

Bis(trimethylsiloxy) Methylsilane

AL-501 from AG Chemetall in Frankfurt Germany

The slurry 80 can use silane neat or as an alcohol solvent solution. The solvent solution will contain a lower alcohol such as methanol, ethanol, propanol or the like. Ethanol and methanol are preferred. One silane solution may be an organofunctional silane such as BTSE 1,2 bis(triethoxysilyl) ethane or BTSM 1,2 bis(trimethoxysilyl) methane. The viscosity of the slurry for application through the methods to be discussed will require the addition from time to time of an alcohol such as methanol, ethanol, propanol, or others with higher orders to carbon chain basic molecules. Depending on the application method, the slurry may need to be more flowable to enable spraying or flow through an inkjet nozzle, or if applied by brush, it may be desirous that the application be not runny so the higher orders of alcohol would seem to be preferred. It is essential that the silane is not hydrolyzed, otherwise water would be introduced into equipment used in the coating process and have deleterious effects.

Silane is preferred over alternative binders that would need to be fully eliminated from the coating. During heating, with even minor presence of oxygen, alternative binders such as Cotronics 4BE would form COx, some form of carbon-oxygen which either becomes incorporated as a carbide, making the coatings very brittle, or bubbles of gas, making the coating porous. BTSE, although it has some of the COx, is mostly incorporated into the coating as a silicide. Nickel based superalloys contain Mo, W, and Ta, which are poor in high temperature oxidation, but their silicides are insoluble particles with extremely high melting points and very good in high temperature oxidation.

Determination of a preferred nominal composition may be performed by the comparison and analysis of a successful coating composition by SEM-Microprobe using WDS sensing, and then by calculation of the desired weight or atomic percentage of the coating. As will be apparent to one skilled in the art of superalloy coating development, several trials would enable tuning the nominal composition to give the final desired coating in accordance with the teachings provided herein. Silane as the binder increases the silicon content of the coating. Silicon forms dissolution resistant particles with many metals, such as Chromium Silicides. US 2008/0096045, incorporated herein by reference, describes chromium silicide formation, which have been demonstrated to provide good hot corrosion and high temperature oxidation.

In one embodiment of the method, a slurry 80 with a nominal composition is obtained by mixing a non-hydrolyzed silane 82 and a metal powder 84, where the metal powder 84 includes one or more of the following in an amount to form the basic coating: nickel, chromium, cobalt, titanium, rhenium, platinum, aluminum, silicon, palladium, rhodium, zirconium, hafnium, and yttrium. Preferably the mixture will have an absence of iron, tantalum, molybdenum, tungsten, all alkali earth metals (except Calcium) and all alkaline metals, along with the coinage metals of silver, gold and copper. It may be possible to include Calcium although this is not yet verified.

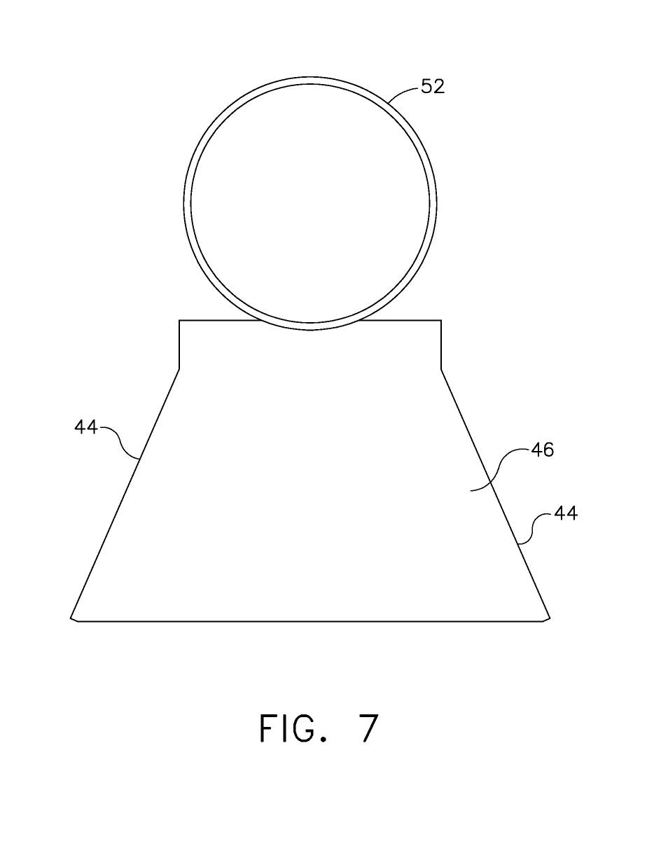

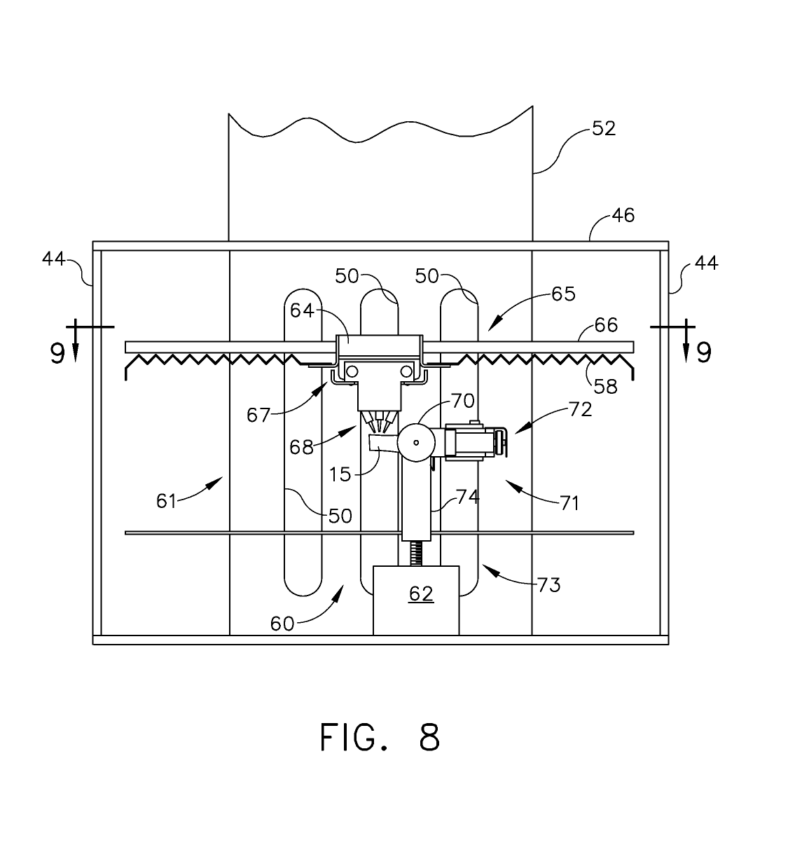

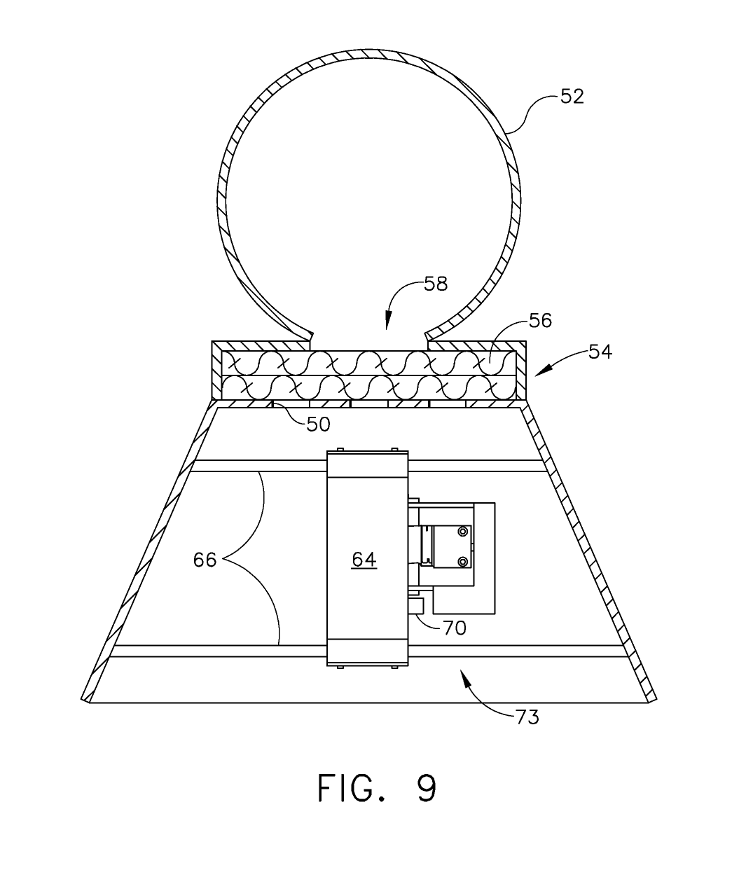

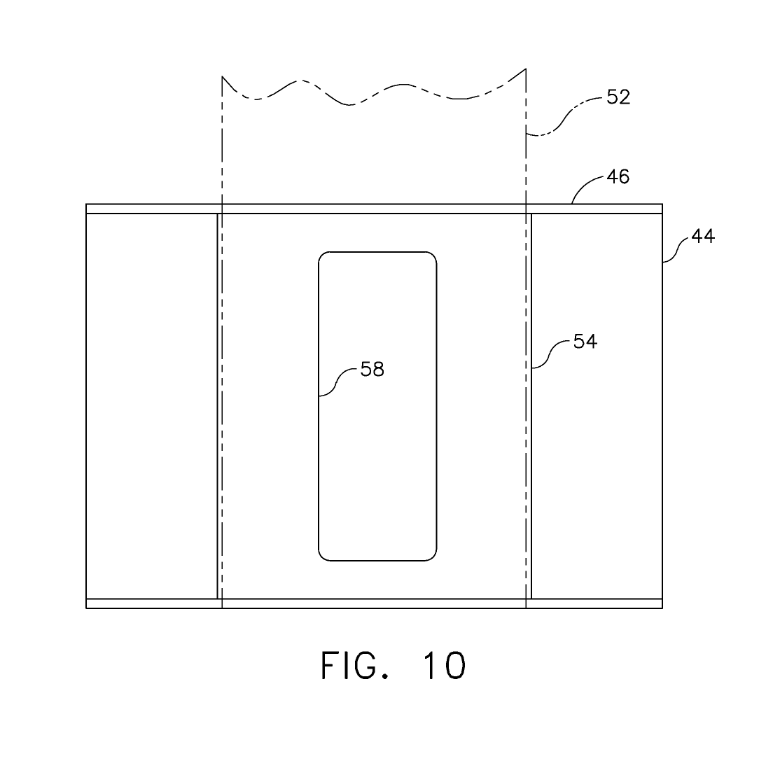

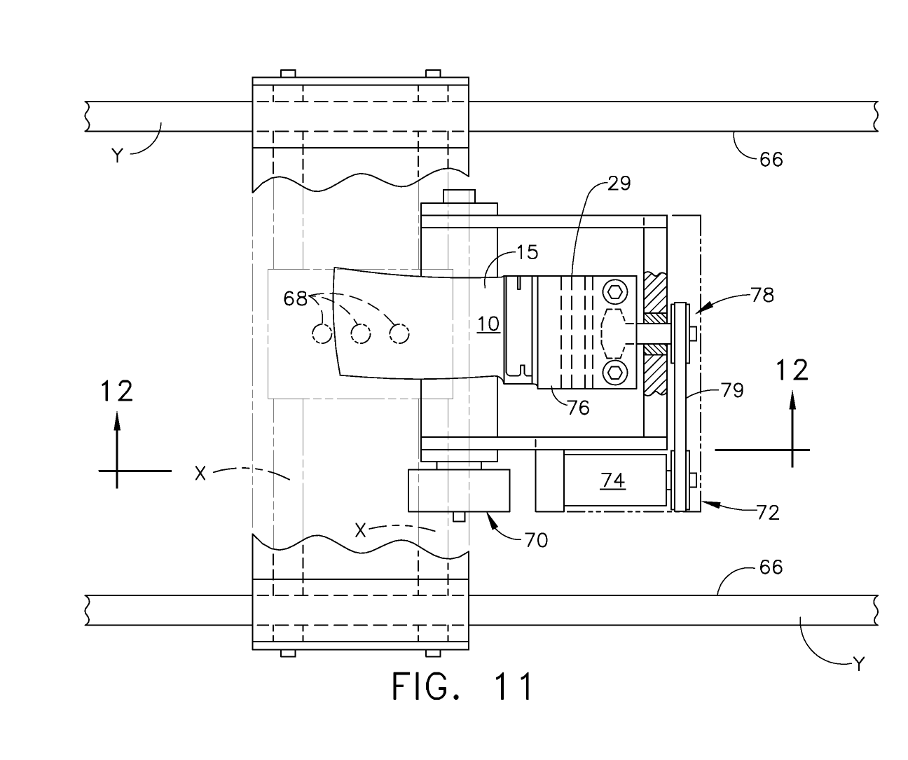

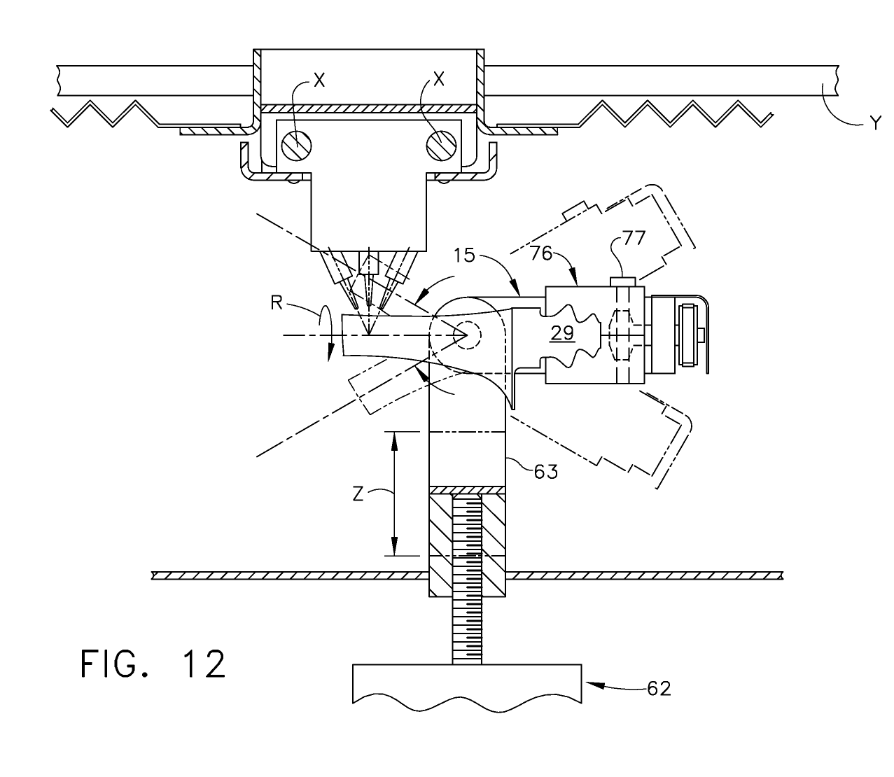

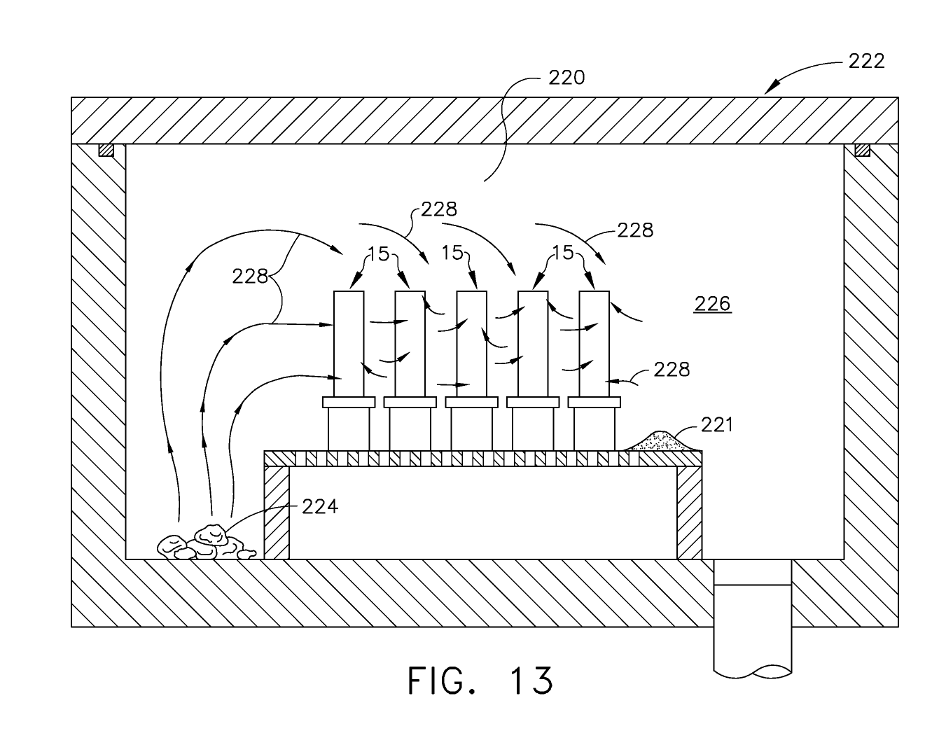

In one method, a mixture of 25% to 50% BTSE (as a binder with an alcohol can be used with pure metal powders. 4% chromium powder, 2% silicon powder, 2% aluminum powder, and 0.2% hafnium powder can be mixed with 5 mL of BTSE with 5 mL of Normal Isopropyl alcohol in a glass bottle 88 as depicted in FIG. 4. The bottle 88 is agitated by to maintain the metal powders 84 suspended while the slurry 80 is applied by an air brush system 90 to a surface 86 of a gas turbine engine component 15 which is suspended by a light weight thin wire 92 such as an SS304 stainless steel wire. This wire is attached to a balance scale 94 so as to be able to determine the weight of the component 15 before and after application of the slurry 80. The surrounding area is enclosed with a coating enclosure 40 shaped like a modern day stage, further details of which are shown in FIGS. 7 and 10, and in combination with another system for application of the slurry in FIGS. 8 and 9. The coating enclosure 40 includes a top 46 and a floor 42, with sidewalls 44 angled inward towards the back 48 of the enclosure 40 and exhaust vent slots 50 in fluid communication with an exhaust stack 52 such that air will be withdrawn to pull the alcohol fumes away from the open front and exposure to the operator. A mounting area 43 between the sidewalls is used for locating the component for processing such that the fumes will be withdrawn through the exhaust. A media box 54 can provide a transition between the stage area and the exhaust stack 52 such that filter media 56 can capture any metal powders from the airflow. The operator applies the slurry according to a deposition rate determined for the desired coating. The operator can rotate the part and apply the coating as evenly as desired, or as appropriate apply the coating to a predetermined weight in a particular area, such as on only the concave or convex sides or underneath the platform. When the weight desired is reached, the part will be dried. Quality requires that the operator uniformly apply this slurry to the parts and areas of the article to which the coating is desired and deliberately avoid areas which have been masked to prevent the coating from being applied. Once the pre-determined amount of coating has been applied, the article is removed and dried in an air oven (no special atmosphere required). The temperature of the drying must not exceed 500° F. to prevent disintegration of the silane by the heat. A temperature between 250-400° F. for 30 minutes is desired.

Once an appropriate number of components 15 have been dried they are placed into a coating furnace 222 (see FIG. 13) which has been conditioned for aluminide coating. In one embodiment, aluminiding is accomplished through a vapor phase aluminization of the applied coating. This typically involves the use of Chromium aluminum chunklets 224 and ammonium bifluoride as an activator 221 and by heating the furnace to a temperature near to 1975°. This is performed in an atmosphere where the oxygen content is reduced to between 2 and 10 ppm by argon dilution. The temperature and coatings are allowed to soak at 1975° for 4-9 hours until the diffusion of the metals with the substrate metals is complete. It is then allowed to cool. It is typical to inspect parts for air bubbles prior to moving them to the next process. Any and all air bubbles must be removed and the small areas recoated before further processing. Note that there was no diffusion heat treat prior to the aluminization step, the drying step was well below a diffusion heat treat temperature.

It is the desire of all operators to have gas turbine engine components, such as blades, vanes or shrouds, or IGT Articles Buckets, nozzles and plates to last as long as possible. Yet, the majority still apply uniform coatings rather than coatings which could be applied using this method according to local conditions on the parts.

For example, it would be desirable for a coating underneath the platform to contain chromium while above the platform chromium is not otherwise desirable. Coatings near the root of the blade in the convex fillet would not need as much platinum or thickness as a spot near the tip and trailing edge. It would be desirable that 100% of the blades used in state of the art engines by OEM's today have some arrangement of more than one coating in the various areas, whether by applying thicker coatings of one composition or different compositions to different areas subject to different conditions. Until the present method this would require multiple heat processes which are costly from both a production cost and time point of view.

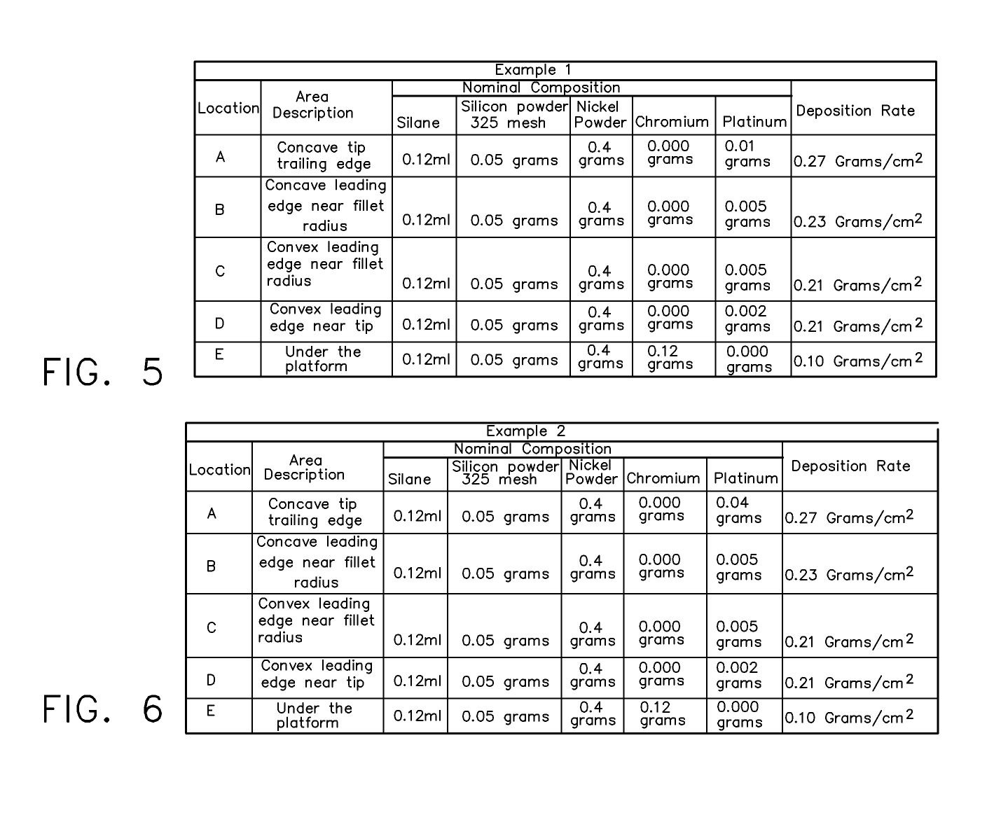

Embodiments of the method teaching coatings applied based on the local environment are provided in Examples 1 and 2 summarized in FIGS. 5 and 6, respectively. FIG. 5 provides an example of how to apply slurry to different areas, denoted Locations A, B, C, D and E, according to the method based on the respective temperature environments for a blade with a thermal barrier coating applied on the flowpath portion 11 of the blade 10. FIG. 6 provides an example of how to apply slurry to different areas, again denoted Locations A, B, C, D, and E, according to the method based on the respective temperature environments for a blade without thermal barrier coating and only an environmental coating.

In Example 1, locations B and C have the same composition of slurry applied but at different deposition rates, measured in grams per square centimeter. The slurry applied to location A has a much higher platinum concentration than all other locations. The slurry applied to the location D has a lower platinum concentration than the other flowpath surface areas. Location E, under the platform and thus a non-flowpath surface think, has no platinum but does include chromium which none of the flowpath surface areas required.

In Example 2, locations B and C likewise have the same composition of slurry applied but at different deposition rates. The slurry applied to location A has a much higher platinum concentration than all other locations, and as it is not under a TBC, is much higher than the similar location of Example 1. The slurry applied to the location D again has a lower platinum concentration than the other flowpath surface areas. Location E, under the platform, also has no platinum but does include chromium which none of the flowpath surface areas required.

In both examples, subsequent to applying the noted slurries, the method would continue with the steps of drying the slurries and placing the component in a furnace for aluminization. From these examples it is clear that the method can be used to obtain different coatings in different areas of a gas turbine engine component, including variations in both composition and deposition rates, i.e., distinct nominal compositions and/or distinct deposition rates.

In addition, when it comes to forming IGT coatings which are much thicker, the method can be used to apply a thicker coating of the same chemistry rather than resulting in a gradient where the chemistry changes over the thickness.

Methanol is preferred as the solvent to maintain a constant viscosity of the mixture as it is being applied. One mixture of metals being applied to one blade or vane is preferred to control the metal content per part to eliminate or reduce part to part variability.

Methanol can be condensed after the drying process and recovered so that no VOC's (volatile organic compounds) escape to the atmosphere. To accomplish this an activated carbon mass will be placed into the exhaust stack (52) of the coating enclosure (40). A chiller will produce a cold trap from which pure methanol can be recovered.

The methanol can be replaced by any one of a number of other solvents, the normal pure solvents being methanol, ethanol, propanol, (Isopropanol), butanol, pentanol, etc. . . .

In another embodiment, the liquid base for the slurry 80 is BTSE, 20% by volume, and 80% by volume of butanol. The powders are immersed into this liquid mixture on the order of 30% by weight platinum, 5% weight chromium, 5% weight nickel powder, 3% weight cobalt powder, aluminum 20% by weight, silicon 4% by weight, rhenium 2% by weight, and balance zirconium oxide powder. All powders described herein are specified as less than 325 US Std mesh sieve sizes and procured according to American Chemical Society ACS reagent grade powders. Alpha Aesar is one source of these materials. BTSE may also be obtained from Alpha Aesar, as can all of the alcohols.

The gas turbine engine component 15 is suspended by a light weight thin wire such as an SS304 stainless steel wire. This wire is attached to a balance scale so as to be able to determine the weight of the article before application of the slurry and then afterwards. To obtain adequate quality it is essential that the operator be trained to monitor the weight gain at all times during the process. It is essential that the operator uniformly apply this slurry to the areas of the component 15 to which the coating is desired and deliberately avoid areas which have been masked to prevent the coating from being applied. Once the pre-determined amount of coating has been applied, the component 15 is removed and dried in an air oven as in the previous embodiment and undergoes the aluminide process as described above.

In the past it has been practice to perform an age heat treatment for further diffusion and reduction of the brittleness of the coating. This coating is not brittle so no age heat treatment is required, but may be performed at the choice of the operator.

It is essential that this slurry composition be continuously mixed during application. The simplest method of application is by airless spray using a hobby sized system for application. This spraying must be done in a spray booth where the incoming air is drawn past the operator and past the article and then into the dust collection device for capture. 100% of the overspray, if any, must be captured to recover the platinum and/or rhenium values.

It would be desirous to have a single operation that could be performed to completely apply the desired coatings in a designer fashion in one pass. Diffusion could then be applied to finish the coating.

In one embodiment of the method to apply a superalloy coating a piezoelectric dot matrix printer can be used. Currently available printers provide as many as four heads with four separate colors, which would enable four separate metal recipes to be utilized permitting designer coatings to be applied. Current versions of stereo lithography devices or other robotic devices available through the internet could easily be adapted to apply the coatings as desired. Routine experimentation by one of ordinary skill in the art of superalloy coating application would permit the deposition to be made according to the desired results.

Typical coatings today are performed with the resultant coating before operation being in the range of 0.0025″ to 0.0045″. This range is easily in the range of a printer in one pass or to make sure the metals are distributed as desired in multiple passes. The parts could then be dried as in method One above. It is possible that a complete coating could be comprised in a recipe such that over aluminization was not required. If so then this process could be considered a replacement for the PW Catarc and the EB-PVD Application of MCrAIY coatings performed by certain OEMs′. Or the same aluminization as described above could be applied. Further after aluminization it is possible to apply a finishing coating of something like a silicide of one metal or another. Such an application would dramatically extend the life of the article.

Non-uniform coatings with thicker dimensions in certain desired locations would be enabled. Chemically non-uniform coatings would also be possible.

The spraying of masking materials on surfaces like the pressure faces 30 of root fir tree features on blade articles could be accomplished as well.

The deposition of 2D bar code features on the forward face 31 and/or aft face 33 or bottom of the blade root 28 could incorporate the Part Number of a serial number of the articles as is currently performed by dot matrix laser printers or peening systems.

An alternative embodiment provides a process for forming platinum aluminide without electroplating platinum and utilizing the teachings herein has been developed. This method enables platinum to be efficiently applied to the surface of the component without the losses associated with electroplating by brushing or otherwise applying a fluid solution containing a slurry mixture of platinum powder and silane.

Non-hydrolyzed silane is preferred as a binder, by mixing the platinum powder with silane and then applying the slurry mixture to the part using any one of the several manual application methods of dipping, brushing or spraying the slurry onto the part substantial savings can be obtained.

The weight of the part is monitored during the deposition step. A four digit scale with a least count of 0.0001 grams can be used. The rate at which the silane dries can be used to make sure that the part is adequately covered in all areas while not requiring masking when a paint brush is used. Observed and calculated data can enable appropriately making the platinum a bit thicker where needed and thinner where not needed. The work of Don Boone, BLD Turbines Canada describes isotherms on the part which means not all areas operate as hot as the tips and trailing edges. I have determined, therefore, it is an advantage to know where to put a bit of additional platinum in terms of blade life.

In plating, areas like the tips and trailing edges get thicker, sometimes exceeding the blueprint specifications. The second step of formation of platinum aluminide is a diffusion step followed by aluminization. When the platinum is too thick, you get a yellow phase forming which is Pt2Al. This phase is very brittle. If this were a leading edge and struck by any of the typical debris in an engine, then it may spall off. Placing this slurry as described onto the part takes advantage of the normal natural tendency of fluids to retreat from sharp edges. In this manner the thick buildup on thin and sharp surfaces can be avoided.

With reference to FIGS. 2-4 and in accordance with the principles taught herein, a platinum and silane containing slurry is applied to a surface 16 of a gas turbine engine component 10 prior to an aluminizing process such as CVD. The platinum and silane containing slurry (80) may be applied such as by a paintbrush to form a platinum and silicon containing layer as it dries before aluminiding. The exemplary gas turbine engine component 10 depicted is a turbine blade 15 which includes an airfoil segment 12 designed to be in the hot airflow path (as indicated by arrows 17), extending from a platform 21 upper surface 23 and an integral root 28 with a contoured surface 30 extending below the platform 21 and used to secure the blade to the turbine disk (not shown). The airfoil segment 12 includes a pressure side 18 and a suction side 20 extending between a leading edge 14 and a trailing edge 16. The blade airfoil segment 12 includes internal cooling channels or passages exiting to the flowpath through surface cooling holes 32 on original surface 86 so as to permit cooling air to pass through the interior of the airfoil segment 12 while the blade is in service on the gas turbine engine. Portions of the airfoil segment 12 and platform upper surface 23 may have different amounts of the platinum and silane containing slurry applied as appropriate to achieve the desired platinum thickness to enable formation of a platinum aluminide coating having the desired thickness based on the particular temperature environment for that portion.

Howmet produces a coating called MDC150L. It is formed by platinum plating using the “A” salt, hexahydroxy platinum II. MDC′150L has been considered a superior coating in the marketplace. It has been claimed that the use of the A salt eliminated both sulfur and phosphate from getting into the coating. Sulfur in the plating bath can be measured, but the source of whence it came has not been determined. Phosphate is used as the conductive electrolyte in the bath. There is no doubt that both of these elements are entrapped in the coating as contaminants, and that eliminating them would be advantageous. There is no sulfur, nor phosphate in the silane platinum slurry described.

MDC150L does not utilize the diffusion step after plating but instead goes straight for dynamic CVD overcoating. The method taught also eliminates the need for the platinum diffusion.

Assuming the platinum particles are fine enough to pass through the ASTM US Std seive size 325 or smaller, then the maximum sized particle would be 0.003″ in diameter. The melting point of aluminum is 1220° F. Silicon in the form of silicon is a melting point depressant. Each platinum particle appears to be surrounded with sufficient silicon and then overflooding the particle with a surplus of aluminum such that the platinum particles melt into the matrix of aluminum silicon. Samples have been produced which exhibit a surface finish which compares exactly with the normal results from the Snecma Vapor phase process of better than 68 RA, smooth enough for turbine use without polishing.

Other powders can also be incorporated into this process, like chromium, and hafnium. This method is separate and distinct from U.S. Pat. No. 7,229,701 and can provide an improvement in platinum aluminide performance.

The process has several advantages over previously used processes. It can be utilized to reduce the amount of a platinum used in order to achieve a level of platinum actually applied to the part, eliminates the electroplating problems, is faster and less labor intensive than the current process, eliminates sulfur and phosphate incorporation, permits rapid statistical process control on the amount of platinum applied (please note the substantial difference between platinum at 195 grams per mole and silicon at 28 grams per mole), can be applied from a table top eliminating the equipment needed for platinum and the ventilation systems and operation, and essentially eliminates the waste. Desired coating differences across different areas of a part are readily achieved in an efficient process.

Buttons were produced and have undergone High Temperature Cyclical Oxidation testing. At 2050° F. 800 hours of testing would be equivalent to 10,000 hours in an engine operating at 1700° F. Samples have shown they are still being protected by their coatings despite surviving 1000+ hours of testing.

In application of the method, further issues have been considered that led to further developments of coating considerations and apparatus for applying the coating(s) using the slurry method. It has been proven that the mixing of chromium powders, using BTSE (A silane formulation) results in a coating which is 3× more resistant to hot corrosion in isothermal testing than platinum aluminide. This work was completed at Cranfield University near London more than 5 years ago. Further research into the application of platinum from a non-aqueous source that is without electroplating, can be accomplished using BTSE as a binder in a slurry application. The parts resulting have identical coating morphology as compared to normal platinum applied by electroplating. The application of coatings from slurry sources is well known. This new technology is an attempt to be able to apply numerous metallic coatings without the expensive methods like CATARC, or EB-PVD as are now being applied.

A silane diluted by an alcohol can be mixed with a metal powder, or metal powders, and placed into the reservoir of a piezo-electric inkjet printer head. Of the various types of inkjet printers piezo-electric was selected because it is essential that the powders be continuously agitated to prevent separation by weight.

The system must provide a mechanical mechanism which is blade specific meaning each blade will have a unique set of tooling to hold the blade. The blade will be held convex side up, and essentially horizontal along the stacking axis of the blade. The ability to tilt up or down by 30° in each direction must also be provided. We prefer that the holding fixture be secured onto each blade using hex head screws and a Allen type tool. The fixture may not scratch mar, dent or misfigure the dovetail surfaces in any way. The dovetail fixture must entirely mask the dovetail pressure faces from any overspray.

Depending upon the blade and the length of the shank area of the blade, we may wish to spray a different coating below the platform. TO accomplish this then the blade would be rotated down and the opposite side by performing a 180 degree rotation, then deflecting the blade up.

The holding fixture described above must also provide one axis of 360° degrees of rotation about the stacking axis of the blade. This rotation must be accurate to within 1 degree of rotation.

There will be a gantry like structure sliding on two rails forward and backward. The rails will be precision ground as is typical in devices such as this. The system must provide protection for the rails and the sliding bearings in the legs of the gantry to prevent overspray from entering and depositing on the rails.

Three piezo electric inkjet devices will be mounted onto the gantry. If the direction of the axis of the gantry movement is defined as the x direction, then the three inkjet heads must be mounted so as to provide the y direction in their movement joint, all three move at once.

To provide one pass of spray onto the blade, then the system will locate just one head over the part, near the platform of the blade, turn on one head containing the correct recipe, then move single axis in the x direction to the end of the blade, turn off the inkjet and return to home. Then move over one width of spray, turn on and go again. Repeat until coated.

Rotate the part 180°, repeat until blade is entirely coated.

2. Mechanical Requirements

Each blade weighs from 25 grams to 1000 grams, the system must accommodate each and all. It must be easy and quick to change the tooling for holding the dovetails of the blade.

The rate of movement in the x direction is between 3 inches per second and 5 inches per 10 seconds. Speed must be programmable. The rate of rotation of the tooling head is 360 degrees in 10 seconds.

The three piezo electric inkjets are planned for the following purposes: 1. normal coating recipe 2. under the platform recipe 3. maskant recipe.

The gantry travel path must be a minimum of 10 inches long. The gantry width must be a minimum of 5 inches wide. The weight allowed for the piezo electric inkjets is 2 pounds each, including the weight of the coating slurry for a total weight of three pounds each.

3. Ventilation Requirements

Air must be pulled past the front where the operator is intended to stand, towards the back and away from the operator. There must be a mesh screen filter provided to catch the overspray and recover it as the metals are valuable.

The velocity of the air moving past the operator must be adjustable from 2-3 feet per minute to five feet per minute. It is desirable that a clear plastic shield be placed over the entire structure. The shield must be easily removable to permit the operator to load and unload the blade and to add the slurry recipe to the inkjet cartridges.

The fluid used in the ink cartridges is diluted with alcohol. Evaporation of alcohol may be flammable. The ventilation system must take that into account.

4. Electrical Requirements

The electrical controls must be housed in a control enclosure. The enclosure must comply with both US NFPA 70 latest edition and European CE requirements. Since it is not possible to simultaneously comply with both, the subcontractor applying the components must utilize components which are marked with both UL and CE approvals. Wiring colors according to the country that the system will be shipped to must comply with that countries ratings either UL or CE.

The system should be either 120 volts AC, or 240 volts AC, single phase. The system will convert as needed to provide DC voltage to the drives. The drives are enumerated:

1. Rotational axis to rotate the parts DC Stepper motor.

2. Tilt axis to provide the motion tilting the parts (May be air cylinder with adequate logic sensors).

3. Axis to drive the x axis forward and backward (DC Stepper with ball screw).

4. Axis to drive the y axis to the left and right (DC Stepper with ball screw).

5. A second y axis to move the three inkjet devices left and right on the gantry (DC Stepper Motor with ball screw).

The electrical distribution to the gantry and the inkjet devices will be festooned from above in such a way as to not apply any mechanical load to the devices. The festoons shall not obstruct the operator's view in any way.

The following axes will be coordinated such that relative motion in one axis is proportionally controlled with another axis in a different direction:

No axes will require coordination.

5. Software Controls

Then system will be made using an AB PLC 1500 to control the system. The system will require an engineer to plan to spray paths needed to coat each part. Each part will have a unique pattern of spray per part number but each part with the same part number will receive the same program. The operator will sit in a chair in front of the system, and select the part number program from the list available. He will load the part into the fixture and make sure the reservoirs have adequate slurries of the correct amount. When conditions are ready, he will tell the PLC to go by punching a button. The program will prompt the operator for the Serial Number. The system will edit for correctness as much as is possible. The system will start, turn on the red light. When complete, the system will notify the operator by turning on a green light. The operator will weigh the part before application, and after, entering the data into the computer. The computer will calculate if an adequate amount of material was added.

The system will permit the engineer to decide how much weight must be added in four locations, CONCAVE Under the platform, Concave remainder above the platform, Convex below the platform and Convex above the platform. All four weights may be taken if desired.

All operator software will be programmed in Visual Basic.

The plan for designing the spray paths is not fully designed yet. Item open.

The system will be based upon Windows 7 or higher operating system. It is expressly forbidden to provide an Internet interface to this system. It must be free standing and backed up with an Interruptible Power Supply. Data backups will be performed and not be using the CLOUD.

6. Colors and Finishes

The mechanical portion of the system will be made and fabricated onto a sturdy steel base, which is powder coated into a white color. The mechanical shields for protecting the system from overspray will also be applied white. The drives will be the color provided by the drive vendor.

The three linear movement platforms, Axis 3, 4 and 5 will be fabricate from a correct grade of steel and also powder coated a light tan to brown color. The control cabinet will be an antique white powder coating.

What is claimed is:

1. A method of forming a coating (36, 37) on a gas turbine engine component (15), comprising:
mixing a first slurry (80) having a nominal composition comprising a non-hydrolized silane (82) and a metal powder (84), wherein the metal powder (84) comprises one or more of the group consisting of Ni, Cr, Co, Ti, Re, Pt, Al, Si, Pd, Rh, Zr, Hf, and Y;
applying the first slurry (80), at a first deposition rate, to a surface (86) of a first area of the gas turbine engine component (15);
drying the applied first slurry (80) on the surface (86) of the first area;
placing the gas turbine engine component (15) in a furnace (220) and heating the gas turbine engine component (15) in a single heating cycle to form the coating.

2. The method of claim 1 wherein the slurry comprises Al in sufficient amounts that an aluminide coating is formed during the heating process without an additional source of aluminum.

3. The method of claim 1 wherein the heating cycle is a vapor phase aluminization cycle.

4. The method of claim 2 or 3 wherein the metal powder (84) comprises a platinum powder (84) and the aluminide formed comprises a platinum aluminide coating (36, 37) on the first surface (86) coated with the first slurry (80), the platinum aluminide coating having an absence of sulfur and an absence of phosphorus.

5. The method of any one of the preceding claims wherein the gas turbine engine component (15) has a flowpath portion (11) having a surface (86) including the first area, and the gas turbine engine component (15) has non-flowpath portion (25) having a surface (86) including a second area, the first and second areas being subject to different thermal environments during engine operation, and wherein the first slurry (80) is applied to the surface (86) of the first area, further comprising the steps, prior to the heating step, of:
mixing a second slurry (80) having a nominal composition distinct from the nominal composition of the first slurry (80), the second slurry (80) comprising a silane (82) and a metal powder (84), wherein the metal powder (84) comprises one or more of the group consisting of Ni, Cr, Co, Ti, Re, Pt, Al, Si, Pd, Rh, Zr, Hf, and Y;
applying the second slurry (80), at a second deposition rate, to the surface (86) of the second area; and
drying the applied second slurry (80) on the surface (86) of the second area.

6. The method of claim 5 wherein the second slurry (80) further comprises a powder selected from the group consisting of chromium and hafnium.

7. The method of any one of the preceding claims, wherein the gas turbine engine component (15) is not subjected to a diffusion heat treatment prior to the heating step.

8. The method of any one of the preceding claims, wherein the gas turbine engine component (15) has a flowpath surface (86) including a first flowpath area (A, B, C, D) and a second flowpath area (A, B, C, D) that are subject to different thermal environments during engine operation, and further wherein the first area is the first flowpath area (A, B, C, D), further comprising the steps, prior to the heating step of,
applying the first slurry (80), at a second deposition rate distinct from the first deposition rate, to the surface (86) of the second flowpath area (A, B, C, D); and
drying the applied first slurry (80) on the surface (86) of the second flowpath area (A, B, C, D).

9. The method of any one of the preceding claims wherein the gas turbine engine component (15) has a flowpath surface (86) including a third flowpath area (A, B, C, D) and a fourth flowpath area (A, B, C, D) that are subject to different thermal environments during engine operation, further comprising the steps, prior to the heating step, of:
mixing a third slurry (80) having a nominal composition comprising a non-hydrolized silane (82) and a metal powder (84), wherein the metal powder (84) comprises one or more of the group consisting of Ni, Cr, Co, Ti, Re, Pt, Al, Si, Pd, Rh, Zr, Hf, and Y;
applying the third slurry (80), at a third deposition rate, to the third flowpath area surface (86);
mixing a fourth slurry (80) having a nominal composition distinct from the nominal composition of the third slurry (80), the fourth slurry (80) comprising a non-hydrolized silane (82) and a metal powder (84), wherein the metal powder (84) comprises one or more of the group consisting of Ni, Cr, Co, Ti, Re, Pt, Al, Si, Pd, Rh, Zr, Hf, and Y;
applying the fourth slurry (80), at a fourth deposition rate, to the fourth flowpath area surface (86)
drying the applied third and fourth slurries (80) on the surface (86) of the third and fourth areas.

10. The method of any one of the preceding claims wherein the silane (82) is BTSE, 1,-2 bis (triethoxsilyl) ethane.

11. The method of any one of the preceding claims wherein the slurry (80) has a viscosity, further comprising an alcohol to control the viscosity of the slurry (80).

12. The method of any one of the preceding claims wherein application of the slurry (80) is performed using a 3-D print system (60).

13. The method of claim 12 wherein application of the slurry (80) is performed by a piezoelectric dot matrix printer (67).

14. The method as claimed in any one of the claims 1 to 11, wherein application of the slurry (80) is performed by a spray process.

15. A gas turbine engine component (15) having a platinum aluminide coating (36, 37) formed by the method of any one of the preceding claims, wherein the platinum aluminide coating (36, 37) comprises platinum, silicon, and aluminum, with an absence of sulfur and phosphate.

16. A gas turbine engine component (15) having a coating (36, 37) formed by the method as claimed in any one of the claims 1 to 14, the coating (36, 37) comprising:
silicon, aluminum, and one or more elements selected from the group consisting of Ni, Cr, Co, Ti, Re, Pt, Pd, Rh, Zr, Hf, and Y; and
an absence of iron, tantalum, molybdenum, tungsten, all alkali metals, and all alkali earth metals with the exception of calcium.

17. A gas turbine engine blade (10) having a platform (21) with an upper surface (23) and a lower surface (26) extending from a forward end (13) to an aft end (19), an airfoil (12) extending from the platform upper surface (23) at a fillet radius (24) outward to the blade tip (22) with a concave side (18) and convex side (20) each extending from a leading edge (14) proximate the forward end (13) to a trailing edge (16) proximate the aft end (19), the platform upper surface (23) and surfaces of the airfoil (12) forming a flowpath portion (11) of the blade (10), a non-flowpath portion (25) of the blade (10) including a blade root (28) extending inward from the platform lower surface (26) to a lower dovetail section (29) which extends longitudinally from a forward face (31) to an aft face (33), the dovetail section (29) having pressure surfaces (30); wherein
at least one area (A, B, C, D, E) of a surface (86) of the blade (10) having a coating (36, 37) formed by the method as claimed in any one of the claims 1 to 14.

18. The gas turbine engine blade (10) of claim 17 further wherein the flowpath portion (11) includes a first area (A, B, C, D) and the non-flowpath portion (25) includes a second area (E), wherein the first area (A, B, C, D) and the second area (E) include a first coating (36, 37) and second coating (36), respectively, formed by the method as claimed in any one of the claims 5 to 14.

19. The gas turbine engine blade (10) of claim 18 wherein the first coating (36,37) has an alumina forming composition resistant to high temperature oxidation and the second coating (36) has a chromium containing composition resistant to sulfidation.

20. A 3-D print system (60) for use in coating a gas turbine engine component (15) comprising:
holding apparatus (71) to enable locating areas of the gas turbine engine component (15) for application of a coating,
application apparatus (61) for automatically applying a silane based slurry (80) containing a metal powder (84) to a surface of the gas turbine engine component (15),
wherein the application apparatus (61) enables the metal powder (84) to remain suspended in solution through the application process.

21. The 3-D print system (60) of claim 20 wherein the application apparatus (61) comprises a 3-D printer (65).

22. The 3-D print system (60) of claim 21 wherein the 3-D printer (65) comprises a piezoelectric dot matrix printer (68).

23. The 3-D print system (60) of claim 21 or claim 22 wherein the holding apparatus comprises a gantry system (60) providing multiple degrees of freedom for orienting the gas turbine engine component (15) with respect to the application apparatus (68).

24. The 3-D print system (60) of any one of claims 21 to 23 further comprising an exhaust system including a vent stack (52) for withdrawal of gases from a staged area (40) for holding the gas turbine engine component (15) during the application process as claimed in any one of claims 1 to 13, wherein the staged area (40) includes:
a mounting area (43) wherein the gas turbine engine component (15) is located during application of the coating (36, 37),
bottom (42), side (44) and top (46) surfaces for directing airflow to a rear surface (48) including openings (50) in fluid communication with an exhaust duct (52).

25. The 3-D print system (60) of claim 25 further comprising filter media (56) substantially adjacent and in fluid communication with the rear surface (48) to capture powders from the airflow.

26. A coating enclosure (40) comprising a floor (42) with sidewalls (44) angled inward from an open front towards a back wall (48), and a top (46), the back wall (48) including exhaust vent slots (50) in fluid communication with an exhaust stack (52), the floor (42) providing a mounting area (43) for use in the practice of the method as claimed in any one of claims 1-14.

27. The coating enclosure (40) of claim 26 further comprising a media box (54) providing a transition between the back wall (48) and the exhaust stack (52), the media box (54) containing filter media (56) for capturing metal powders (84) from the exhaust airflow.
